(19) United States
(12) Patent Application Publication
(10) Pub. No.: US 2020/0106919 A1
(43) Pub. Date: Apr. 2, 2020

(54) IMAGE PROCESSING DEVICE, IMAGE SCANNER AND IMAGE PROCESSING METHOD

(71) Applicant: NIDEC SANKYO CORPORATION, Nagano (JP)

(72) Inventor: Hiroshi NAKAMURA, Nagano (JP)

(21) Appl. No.: 16/582,200

(22) Filed: Sep. 25, 2019

(30) Foreign Application Priority Data
Sep. 28, 2018 (JP) 2018-184080

(51) Int. Cl. H04N 1/387; H04N 1/00; G06T 3/60

(52) U.S. Cl. CPC H04N 1/3878; G06T 3/60; H04N 1/00718

(57) ABSTRACT

An image processing device may include a first image acquisition part configured to acquire first image data including an information recording medium captured under irradiation of light of a first wavelength range, an angle calculation part configured to calculate an inclination angle of the information recording medium based on the first image data, a second image acquisition part configured to acquire second image data including the information recording medium captured at the same position under irradiation of light of a second wavelength range which is different from the first wavelength range and in which contrast of an outline of the information recording medium is low, and an angle correction part configured to prepare corrected image data of the second image data in which an angle correction of the information recording medium is performed based on the inclination angle calculated by the angle calculation part.

### CROSS REFERENCE TO RELATED APPLICATION

The present invention claims priority under 35 U.S.C. § 119 to Japanese Patent Application No. 2018-184080 filed Sep. 28, 2018, the entire content of which is incorporated herein by reference.

### TECHNICAL FIELD

At least an embodiment of the present invention may relate to an image processing device, an image scanner and an image processing method, and especially, relate to an image processing device, an image scanner and an image processing method in which an angle correction and the like of image data obtained by imaging an information recording medium is performed.

### BACKGROUND

Conventionally, an image scanner has been existed which is referred to as a “multi-document scanner” structured to image an information recording medium such as a driver's license and a passport. In such an image scanner, a correction of an inclination (hereinafter, referred to as an “angle correction”) of an information recording medium is required to perform for the scanned image data.

For example, as a prior art, in Patent Literature 1 (Japanese Patent Laid-Open No. Hei 04-255087), a technique is described in which an inclination angle with respect to a scanning direction is acquired at a plurality of positions for each recognition object line, and the inclination angle is stored, and a data extraction range is capable of being changed depending on the stored inclination angle for each object line for recognizing characters.

In an image scanner for imaging an information recording medium, a mark for preventing forgery may be imaged in an invisible wavelength range such as ultraviolet rays or infrared rays in addition to a normal visible light. In this case, especially, contrast of the outline of the image data having been imaged by ultraviolet rays becomes low. However, in the technique described in Patent Literature 1, an inclination of image data having low contrast of the outline is originally unable to be calculated and thus, it is difficult to correct the angle.

### SUMMARY

In view of the problem described above, at least an embodiment of the present invention may advantageously provide an image processing device, an image scanner and an image processing method capable of performing an angle correction of image data in which contrast of the outline is low.

According to at least an embodiment of the present invention, there may be provided an image processing device including a first image acquisition part configured to acquire first image data including an information recording medium captured under irradiation of light of a first wavelength range, an angle calculation part configured to calculate an inclination angle of the information recording medium based on the first image data acquired by the first image acquisition part, a second image acquisition part configured to acquire second image data including the information recording medium captured at the same position under irradiation of light of a second wavelength range whose wavelength range is different from the first wavelength range and in which contrast of an outline of the information recording medium is low, and an angle correction part configured to prepare corrected image data of the second image data acquired by the second image acquisition part in which an angle correction of the information recording medium is performed based on the inclination angle calculated by the angle calculation part. According to this structure, also in the second image data captured under irradiation of the light of the second wavelength range, an angle correction can be performed without utilizing the contrast of the outline of the information recording medium.

In the image processing device in at least an embodiment of the present invention, the angle calculation part calculates respective intersecting points of two parallel straight lines drawn so as to pass the information recording medium with an edge of the information recording medium for either axis of the first image data, and the angle calculation part calculates the inclination angle of the information recording medium based on a distance in a horizontal direction and a distance in a vertical direction between the respective intersecting points having been calculated. According to this structure, the inclination angle can be calculated with easy calculation.

In the image processing device in at least an embodiment of the present invention, the angle calculation part detects four end points based on luminance values in respective lines in each of axial directions, calculates a circumscribed quadrangle of the information recording medium based on the four end points having been detected, and data outside the circumscribed quadrangle are removed from the first image data. According to this structure, unnecessary data are removed in advance and thus, a speed of subsequent image processing can be increased.

In the image processing device in at least an embodiment of the present invention, the angle correction part performs the angle correction of the information recording medium with the center coordinate of the information recording medium as a center of turning. According to this structure, the information recording medium after correction is easily located in the center of the corrected image data and thus, the subsequent processing can be easily performed.

In the image processing device in at least an embodiment of the present invention, the light of the first wavelength range is one of visible light and infrared light, and the light of the second wavelength range is ultraviolet light. According to this structure, an angle of the second image data captured by using ultraviolet light can be corrected by using the first image data with visible light and/or infrared light.

According to at least an embodiment of the present invention, there may be provided an image scanner including the above-mentioned image processing device, a placing part where the information recording medium is placed, a first irradiation part structured to irradiate the light of the first wavelength range to the information recording medium placed on the placing part, a second irradiation part structured to irradiate the light of the second wavelength range to the information recording medium placed on the placing part, and an imaging part structured to capture the first image data and the second image data. According to this structure, in the image scanner such as a multi-document scanner, an image correction process can be easily realized by the image processing device.

According to at least an embodiment of the present invention, there may be provided an image processing method executed by an image processing device, and the image processing method includes acquiring first image data including an information recording medium captured under irradiation of light of a first wavelength range, calculating an inclination angle of the information recording medium based on the first image data having been acquired, acquiring second image data including the information recording medium captured at the same position under irradiation of light of a second wavelength range whose wavelength range is different from the first wavelength range and in which contrast of an outline of the information recording medium is low, and performing an angle correction of the information recording medium with respect to the second image data based on the inclination angle having been calculated. According to this structure, also in the second image data captured under irradiation of the light of the second wavelength range, an angle correction can be performed without utilizing the contrast of an outline of the information recording medium.

According to at least an embodiment of the present invention, an inclination angle of the information recording medium is calculated based on the first image data captured under irradiation of light of a first wavelength range, and an angle correction is performed with respect to the second image data including the information recording medium captured under irradiation of the light of the second wavelength range in which contrast of the outline of the information recording medium is low based on the inclination angle calculated with the first image data to prepare the corrected image data. As a result, an image processing device, an image scanner and an image processing method can be provided which are capable of performing an angle correction also in the second image data in which contrast of the outline is low.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic system configuration diagram of an image scanner in accordance with at least an embodiment of the present invention.

FIG. 2 is a block diagram showing a control and function configuration of an image processing device shown in FIG. 1.

FIG. 3 is a flow chart of an image correction process in accordance with at least an embodiment of the present invention.

FIG. 4A is a flow chart showing details of an angle calculation process shown in FIG. 3, and FIG. 4B is a flow chart showing details of an angle correction process shown in FIG. 3.

FIG. 5 is a concept diagram of an angle calculation process (first image data) shown in FIG. 3.

FIG. 6A and FIG. 6B are concept diagrams of an angle calculation process shown in FIG. 3.

FIG. 7 is a concept diagram of an angle correction process shown in FIG. 3.

FIG. 8A and FIG. 8B are concept diagrams of an angle correction process shown in FIG. 3.

FIG. 9 is a photo of corrected image data having been corrected by an angle correction process shown in FIG. 3.

FIG. 10A is a photo of second image data acquired by image data acquisition processing shown in FIG. 3, and FIG. 10B is a reference example of a graph of a medium edge point deviation.

FIG. 11A and FIG. 11B are concept diagrams of a conventional angle correction process.

FIG. 12 is a photo of corrected image data having been corrected by a conventional angle correction process.

### DETAILED DESCRIPTION

### Embodiments

An embodiment for carrying out the invention (hereinafter, referred to as an “embodiment”) will be described below with reference to the accompanying drawings.

### [Entire Structure of Image Scanner 1]

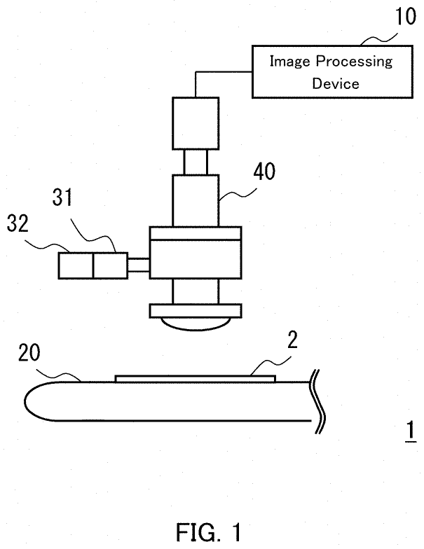

First, a structure of an image scanner 1 in accordance with at least an embodiment of the present invention will be described below with reference to FIG. 1. The image scanner 1 is a device structured to capture an image of an information recording medium 2 and perform various kinds of processing. In this embodiment, the image scanner 1 is a multi-document scanner which achieves reading of information recorded on an information recording medium 2 by using an optical sensor and image processing, for example, in an airport, a public agency and the like.

An information recording medium 2 is a medium having different shapes and specifications, for example, a general card medium conforming to “JIS” (hereinafter, simply referred to as a “card”), a passport, a certificate document, other forms or printed matters. In this embodiment, an example will be described below in which an information recording medium 2 is, for example, a driver's license, an ID (Identification) card, an insurance card, or other cards. These cards are, for example, formed in a rectangular shape (quadrangle or rectangle having long sides and short sides) and are, for example, a plastic card having a size with a width of 86 mm, a length of 54 mm, and a thickness of 0.76 mm. In this embodiment, a surface of an information recording medium 2 is printed or engraved with characters, a photo, a mark or the like which are capable of being visually recognized by visible light. In addition, in this embodiment, characters, a mark or the like which is capable of being visually recognized only by ultraviolet light or infrared light is printed for preventing forgery.

Next, a structure of the image scanner 1 in this embodiment will be described below. The image scanner 1 includes, as main structural elements, an image processing device 10, a placing part 20 and an imaging part 40.

The image processing device 10 is a PC (Personal Computer), a dedicated device or the like configured to process image data. The image processing device 10 recognizes an information recording medium 2 on image data acquired from the imaging part 40, detects a turning angle (hereinafter, referred to as an “inclination”) on the image, and executes an image correction process so as to correct the angle. In other words, as an angle correction, an inclination of the information recording medium 2 with respect to a coordinate axis on the image space is made to be zero. Next, in this embodiment, a configuration relating to the angle correction of the image processing device 10 will be mainly described. The image processing device 10 is also capable of recognizing and decoding characters, a bar-code and the like recorded on the information recording medium 2 from the corrected image data.

The placing part 20 is a table or the like where an information recording medium 2 is placed. In this embodiment, the placing part 20 is structured so as to have a black color or the like and no luster and so that light is hardly reflected.

A first irradiation part 31 is a light source or an illumination unit which irradiates light of a first wavelength range to an information recording medium 2 placed on the placing part 20. The illumination unit is structured so as to include, for example, an LED (Light Emitting Diode), a light guide plate, a diffuser and the like. The LED is capable of irradiating light of a first wavelength range and, for example, includes one of a white LED of a wavelength range of about 380 nm to 780 nm, an infrared LED of a wavelength range of about 780 nm to 1 mm, and the like.

A second irradiation part 32 is a light source or an illumination unit which irradiates light of a second wavelength range to the information recording medium 2 placed on the placing part 20. The second irradiation part 32 includes, for example, an ultraviolet LED of a wavelength range of 300 nm to 400 nm, which is capable of irradiating light of the second wavelength range. In this embodiment, the first irradiation part 31 and the second irradiation part 32 are integrally structured and are distinguished by making the lit LED group controlled by the image processing device 10.

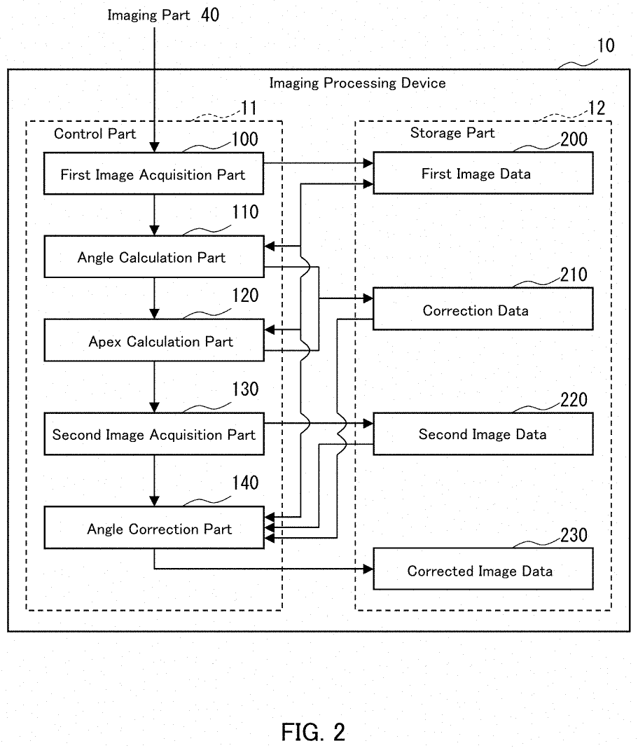

The imaging part 40 includes an image sensor using a photoelectric conversion element configured to detect light to generate electric charge, an optical system (lens and the like) configured to guide incident light to a pixel region of the image sensor (form an object image), an AD conversion part (Analog to Digital Converter) configured to convert an electric signal read from a pixel of the image sensor into digital data, and a circuit configured to convert a format or the like of digital data to transmit the data as the image data to the image processing device 10, and the like. The image sensor is a CCD (Charge Coupled Device) image sensor, a CMOS (Complementary Metal Oxide Semiconductor) image sensor, or the like. In this embodiment, the imaging part 40 is provided above the placing part 20 and captures an image of a specific region including the entire information recording medium 2 illuminated with the first irradiation part 31 or the second irradiation part 32 to output first image data 200 or second image data 220 (FIG. 2) to the image processing device 10.

Next, a control and function configuration when an angle correction is performed by the image processing device 10 will be mainly described below with reference to FIG. 2. In this embodiment, the image processing device 10 includes a control part 11 such as a processor or a controller and a storage part 12 such as a memory. The storage part 12 is connected with the control part 11 through a dedicated bus, connection lines or the like.

The control part 11 integrally controls respective parts of the image scanner 1 and executes various processes including an image correction process. The control part 11 is, for example, structured of a control calculation means such as a CPU (Central Processing Unit), a GPU (Graphics Processing Unit), a DSP (Digital Signal Processor), and dedicated circuits, peripheral circuits for controlling the respective parts, and the like.

The storage part 12 is a non-transitory recording medium in which a control program executed by the control part 11 and data are stored. The storage part 12 includes a main storage part and an auxiliary storage part. The main storage part includes RAMs (Random Access Memory) such as various DRAM (Dynamic RAM) and SRAM (Static RAM). In the main storage part, a control program stored in the auxiliary storage part is developed, and the main storage part serves as a working area where image data captured by the imaging part 40, corrected image data and the like are stored. The auxiliary storage part includes a ROM (Read Only Memory) such as an EEPROM or a flash memory, an HDD (Hard Disk Drive), an SSD (Solid State Drive) and the like. The control program and data are stored in the auxiliary storage part. The control program includes firmware, OS (Operating System), a device driver configured to perform device control of the image scanner 1, an image correction process, an application program for recognition (Application Program, hereinafter, simply referred to as “application”) configured to recognize and decode characters or a bar-code, their control applications and the like.

In addition, the image processing device 10 includes an interface which is connected with the imaging part 40 for controlling and is connected with a host apparatus and a network not shown, a display part such as a display configured to display the captured image data, buttons for operation instruction, a pointing device, and an input part such as a keyboard. In this case, the interface includes, for example, USB (Universal Serial Bus), RS-232C, LAN (Local Area Network) interface, and the like.

In addition, the image scanner 1 also includes a housing for blocking external light, a power supply device, a display device, an operation panel and the like. Moreover, the image scanner 1 may be connected with a host apparatus such as a monitoring PC or a server.

### [Functional Configuration of Image Processing Device 10]

Next, a functional configuration of the image processing device 10 in this embodiment will be described below with reference to FIG. 2. In this embodiment, the control part 11 includes a first image acquisition part 100, an angle calculation part 110, an apex calculation part 120, a second image acquisition part 130, and an angle correction part 140. The storage part 12 stores first image data 200, correction data 210, second image data 220 and corrected image data 230.

The first image acquisition part 100 is an image acquisition part configured to acquire first image data 200. Specifically, the first image acquisition part 100 makes the imaging part 40 image an information recording medium 2 under illumination of the first illumination part to acquire the image as first image data 200.

The angle calculation part 110 calculates an inclination angle of the information recording medium 2 based on the first image data 200 to set in correction data 210. Specifically, the angle calculation part 110 calculates respective intersecting points of two parallel straight lines drawn so as to pass the information recording medium 2 in either axis of the first image data 200 with edges of the information recording medium 2 and then, the angle calculation part 110 calculates an inclination angle of the information recording medium 2 based on a distance in a horizontal direction and a distance in a vertical direction between the respective calculated intersecting points.

In this case, the angle calculation part 110 detects four end points based on luminance values of respective lines in the respective axial directions, calculates coordinates of respective apexes corresponding to a quadrangle (hereinafter, referred to as a “circumscribed quadrangle”) including an image of the information recording medium 2 based on the four end points having been detected, and sets them in the correction data 210. After that, the angle calculation part 110 removes data outside the circumscribed quadrangle from the first image data 200.

The apex calculation part 120 calculates coordinates of the respective apexes corresponding to a quadrangle of the information recording medium 2 (hereinafter, referred to as a “medium quadrangle”) based on the first image data 200 acquired by the first image acquisition part 100 and sets them in the correction data 210.

The second image acquisition part 130 is an image acquisition part configured to acquire the second image data 220. Specifically, the second image acquisition part 130 makes the imaging part 40 image the information recording medium 2 under illumination of the second illumination part to acquire the image as second image data 220.

The angle correction part 140 prepares corrected image data 230 of the first image data 200 and the second image data 220 in which an inclination of the information recording medium 2 is corrected. In this case, the angle correction part 140 turns the information recording medium 2 based on the inclination angle calculated by the angle calculation part 110 to prepare the corrected image data 230.

The angle correction part 140 corrects, for example, the coordinates of the respective apexes calculated by the apex calculation part 120 based on the inclination angle calculated by the angle calculation part 110. The angle correction part 140 acquires pixel values of the pixels of the first image data 200 or the second image data 220 which are located at the coordinates obtained by reversely converting the coordinates of the pixels by the inclination angle for the respective pixels within the quadrangle formed by the respective apexes where the inclination has been corrected to prepare the corrected image data 230.

In this case, the angle correction part 140 corrects the inclination of the information recording medium 2, for example, with the center coordinate of the information recording medium 2 as a center of turning. In addition, when these processes are performed for the second image data 220, the angle correction part 140 removes data outside the circumscribed quadrangle from the second image data 220.

The first image data 200 are image data including an image of the information recording medium 2 captured by the imaging part 40 under irradiation of light of the first wavelength range which is white light or infrared light. The first image data 200 are, for example, configured as bitmap data of gray scale formed by arranging a plurality of pixels in a matrix shape. In the bitmap data, although not shown, pixels of “M” lines in an “X”-axis direction and “N” rows in a “Y”-axis direction are disposed in an initial state captured by the imaging part 40.

The correction data 210 are data for angle correction. In this embodiment, the correction data 210 include the inclination angle, the coordinate data of the respective apexes of the circumscribed quadrangle, the coordinate data of the respective apexes of the medium quadrangle, and the like. In addition, the correction data 210 also include various coordinate data for angle correction such as the coordinate data of the respective apexes and the center of turning of the information recording medium 2. These data are those having been calculated for the first image data 200 as an object to be processed (processing object) and held.

The second image data 220 are image data including the image of the information recording medium 2 captured at the same position under irradiation of light of the second wavelength range whose wavelength range is different from the first wavelength range. The second image data 220 are also bitmap data of gray scale. As described above, the light of the second wavelength range is ultraviolet light in this embodiment. Therefore, in the second image data 220, although a lightness value of a mark or the like generating fluorescence with ultraviolet rays becomes high, contrast of an outline of the information recording medium 2 becomes low.

The corrected image data 230 include corrected image data of the first image data 200 after the angle correction has been performed, and corrected image data of the second image data 220 after the angle correction has been performed. The corrected image data 230 are prepared as an image of the information recording medium 2 in the first image data 200 and a bitmap data group of gray scale having substantially the same size. In addition, the corrected image data 230 also include data such as a character string or a bar-code recognized by OCR (Optical Character Recognition).

In the image data described above, each pixel has each pixel value (luminance value). In this embodiment, for example, in a case of a gray scale of 8 bits, each pixel value takes any value of 0 to 255. The pixel value becomes, for example, smaller as becoming close to black and larger as becoming close to white. In addition, in this embodiment, an example of each bitmap data will be described below in which a horizontal axis is an “X”-axis and a vertical axis perpendicular to the “X”-axis direction is a “Y”-axis.

In this embodiment, the control part 11 executes the control program stored in the ROM of the storage part 12 to be capable of functioning as the first image acquisition part 100, the angle calculation part 110, the apex calculation part 120, the second image acquisition part 130, and the angle correction part 140. In addition, a part or an arbitrary combination of the functional configurations can be structured in a form of a circuit by using an FPGA (Field-Programmable Gate Array) or the like. Further, the control part 11 and the storage part 12 may be integrally configured like an SOC (System On Chip).

### [Image Correction Process]

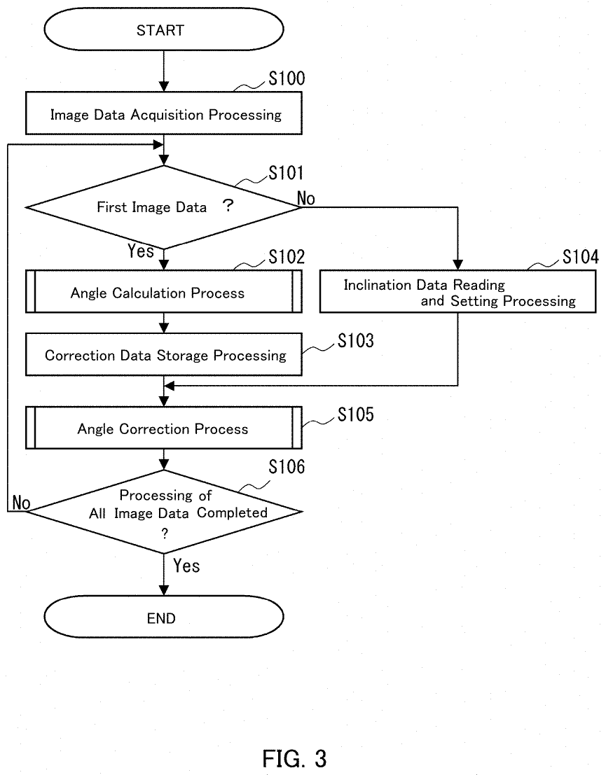

Next, an image correction process in accordance with at least an embodiment of the present invention will be described below with reference to FIGS. 3 through 9. In an image correction process in this embodiment, first image data 200 including an information recording medium 2 captured under irradiation of light of the first wavelength range are acquired. Then, an inclination angle of the information recording medium 2 is calculated based on the first image data 200 having been acquired. Next, second image data 220 are acquired which are captured at the same position under irradiation of light of the second wavelength range whose wavelength range is different from the first wavelength range. The second image data 220 include the information recording medium 2 in which contrast of its outline is low. Then, an angle of the information recording medium 2 is corrected for the second image data 220 by the calculated inclination angle. A turning position data transmission process in this embodiment is performed mainly by the control part 11 which cooperates with the respective parts and utilizes hardware resources to execute the control program stored in the storage part 12. Next, the image correction process will be described below for each step with reference to the flow chart shown in FIG. 3.

### (Step S100)

First, the first image acquisition part 100 and the second image acquisition part 130 perform image data acquisition processing. Each of the first image acquisition part 100 and the second image acquisition part 130 converts an image including an information recording medium 2 captured by the imaging part 40 into image data to store in the storage part 12. Specifically, the first image acquisition part 100 irradiates light of the first wavelength range which is white light or infrared light by the first irradiation part 31. Then, the first image acquisition part 100 captures an image of the information recording medium 2 placed on the placing part 20 by the imaging part 40. The image data obtained in this manner are stored in the storage part 12 as the first image data 200.

Next, the second image acquisition part 130 irradiates light of the second wavelength range which is ultraviolet light by the second irradiation part 32 to capture an image of the information recording medium 2 placed on the placing part 20 by the imaging part 40. The image data obtained in this manner are stored in the storage part 12 as the second image data 220. As described above, the first image data 200 and the second image data 220 are acquired by the first image acquisition part 100 and the second image acquisition part 130 at a time, and the information recording medium 2 is not moved on the placing part 20 or the like and thus, the image of the information recording medium 2 is surely captured in a state at the same position. After that, an angle correction of the respective image data will be executed as follows.

### (Step S101)

Next, the angle calculation part 110 determines whether the first image data 200 are processed or not. The angle calculation part 110 determines “Yes” in a case that the image data of an processing object for which angle correction is to be performed are the first image data 200. The angle calculation part 110 determines “No” in a case that the image data of the processing object are the second image data 220. In the case of “Yes”, the angle calculation part 110 advances the process to the step S102. In the case of “No”, the angle calculation part 110 advances the process to the step S104.

### (Step S102)

In a case that the processing object (object to be processed) is the first image data 200, the angle calculation part 110 performs the angle calculation process. The angle calculation part 110 calculates an inclination angle of the information recording medium 2 based on the first image data 200. Details of the process will be described below.

### (Step S103)

Next, the angle calculation part 110 performs correction data storage processing. The angle calculation part 110 stores the inclination angle of the first image data 200 calculated in the angle calculation process described above in the correction data 210 and holds in the storage part 12. After that, the angle calculation part 110 advances the process to the step S105.

### (Step S104)

In a case that the processing object is the second image data 220, the angle correction part 140 performs correction data reading and setting processing. The angle correction part 140 reads out the correction data 210 held in the storage part 12 and uses them. In other words, the angle correction part 140 acquires the inclination angle and the like of the first image data 200 which are calculated by the angle calculation part 110 from the correction data 210. In addition, the angle correction part 140 removes data outside the circumscribed quadrangle from the second image data 220.

### (Step S105)

In this step, the apex calculation part 120 and the angle correction part 140 perform an angle correction process. The apex calculation part 120 reads out the correction data 210 to calculate coordinate data of the respective apexes of the medium quadrangle and the like. The angle correction part 140 performs an angle correction of the first image data 200 or the second image data 220 by using these data. The angle correction part 140 prepares corrected image data 230 obtained by converting pixel positions so that the inclination angle of the information recording medium 2 becomes zero. Details of the process will be also described below.

### (Step S106)

Next, the angle correction part 140 determines whether the processing of all the image data has been completed or not. The angle correction part 140 determines “Yes” when the angle corrections of the first image data 200 and the second image data 220 have been completed. The angle correction part 140 determines “No” when an angle correction is not performed for the second image data 220. In the case of “Yes”, the angle correction part 140 finishes the image correction process. In the case of “No”, the angle correction part 140 returns the process to the step S101. In this manner, the image correction process in accordance with at least an embodiment of the present invention is finished.

### [Details of Angle Calculation Process]

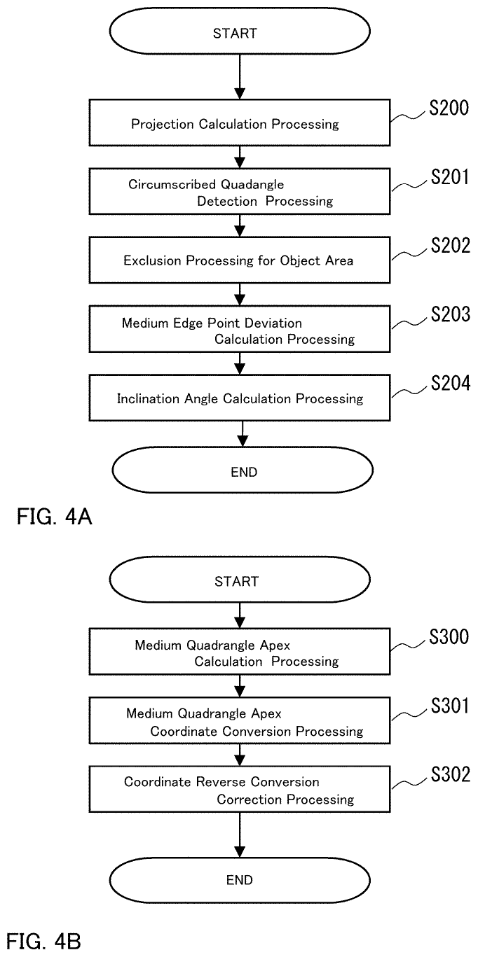

Next, details of the angle calculation process of the step S102 in FIG. 3 will be described below for each step with reference to the flow chart shown in FIG. 4A.

### (Step S200)

First, the angle calculation part 110 performs projection calculation processing. In a case that the image of the processing object is the first image data 200 captured with white light or infrared light as illumination, the angle calculation part 110 performs luminance projection (hereinafter, referred to as “projection”) for each of the horizontal axis (“X”-axis) and the vertical axis (“Y”-axis) of the first image data 200 which are the processing object to prepare “X”-projection and “Y”-projection.

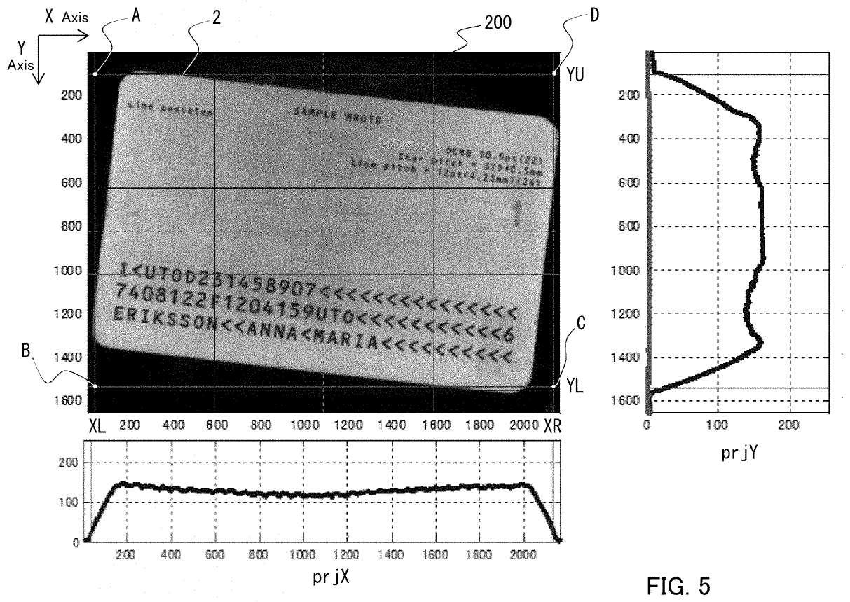

When described with reference to FIG. 5, first, the angle calculation part 110 performs projection for the horizontal axis (“X”-axis) to form the “X”-projection “prjX”. The “X”-projection “prjX” is obtained by calculating an average or a total sum of the luminance values (output value) for each vertical line in a direction perpendicular to the “X”-axis. In FIG. 5, the graph on the lower side indicates the “X”-projection “prjX”. The angle calculation part 110 similarly forms the “Y”-projection “prjY” for the vertical axis (“Y”-axis). The “Y”-projection “prjY” is obtained by calculating an average or a total sum of the luminance values (output value) for each line in a direction perpendicular to the “Y”-axis. In FIG. 5, the graph on the right side indicates the “Y”-projection “prjY”.

### (Step S201)

Next, the angle calculation part 110 performs circumscribed quadrangle detection processing. The angle calculation part 110 scans a waveform of the graph for each of the “X”-projection and the “Y”-projection to determine both end points of the image of the information recording medium 2.

Specifically, the angle calculation part 110 scans the output values of the “X”-projection from both ends toward the center and, when the output values exceed a set threshold value, the points are determined as the right and left end points of the medium. In the “X”-projection “prjX”, the angle calculation part 110 sets the determined end points of the left end part and the right end part in the correction data 210 respectively as the “XL” and the “XR”.

The angle calculation part 110 similarly scans the values of the “Y”-projection from both ends toward the center and, when the values exceed a set threshold value, the points are determined as the upper and lower end points of the medium. In the “Y”-projection “prjY”, the angle calculation part 110 sets the determined end points of the output values of the upper end part and the lower end part in the correction data 210 respectively as the “YU” and the “YL”.

### (Step S202)

Next, the angle calculation part 110 performs exclusion processing for the object quadrangle. The angle calculation part 110 calculates the respective apex coordinates of the circumscribed quadrangle of the information recording medium 2 and excludes or removes data outside the circumscribed quadrangle from the first image data 200.

In the example shown in FIG. 5, the angle calculation part 110 calculates “A” (“XL”, “YU”), “B” (“XL”, “YL”), “C” (“XR”, “YL”), and “D” (“XR”, “YU”) as the respective apex coordinates of the circumscribed quadrangle. In other words, the quadrangle surrounded by the rectangle “ABCD” formed with the positions of both end points in the “X”-axis (horizontal axis) and the positions of both end points in the “Y”-axis (vertical axis) as the four end points is the circumscribed quadrangle.

After that, the angle calculation part 110 removes data outside the circumscribed quadrangle from the first image data 200. Specifically, the angle calculation part 110 cuts out the area surrounded by the rectangle “ABCD” as a processing object area, and an area except the processing object area is excluded and removed. In this case, the angle calculation part 110 is capable of, for example, setting a margin of several pixels to about several hundred pixels.

### (Step S203)

Next, the angle calculation part 110 performs medium edge point deviation calculation processing. In this step, two parallel lines are drawn at positions passing the quadrangle of the processing object area which is cut out from the first image data 200, and the coordinates of edges (hereinafter, referred to as a “medium edge position”) of the information recording medium 2 in the respective parallel lines are calculated and a distance between the positions of the edges in the horizontal direction is calculated.

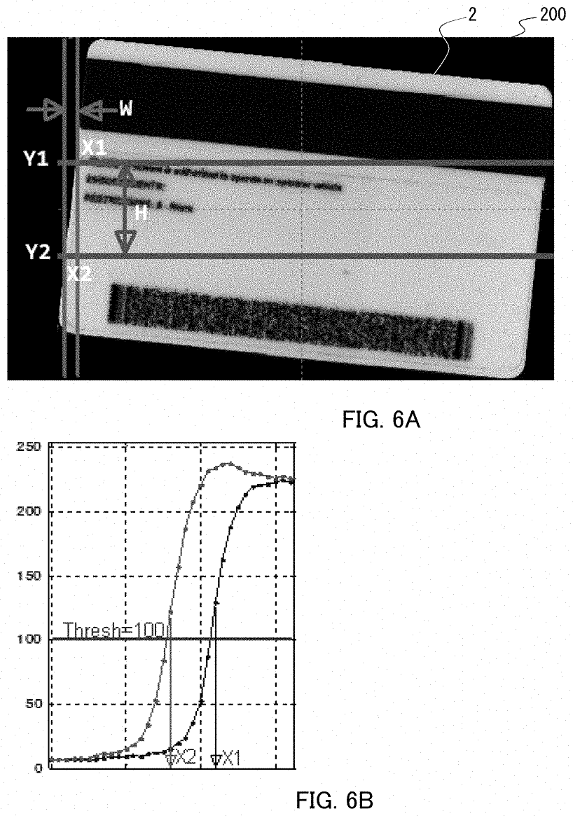

FIG. 6A is a concept diagram when the edge points “X1” and “X2” where the two parallel lines intersect with an edge on the left side of the information recording medium 2 are to be calculated. Specifically, two horizontal lines are drawn within the image of the processing object area. An intersecting point of a first horizontal line with a medium left side edge is the edge point “X1”, and an intersecting point of a second horizontal line with the medium left side edge is the edge point “X2”.

The two curved lines in FIG. 6B respectively show pixel values on the horizontal lines “Y=Y1” and “Y=Y2” in the vicinity of the left edge. The pixel values are respectively checked along the horizontal line to the right direction with the left end of the image as a starting point and, when the pixel values exceed the set threshold value “Thresh”, the points are determined as the edge points “X1” and “X2”.

This example shows a case that a contrast between the medium and the background is comparatively satisfactory and the edge points “X1” and “X2” can be determined comparatively easily. The first image data 200 corresponds to this case in which the image is captured by irradiating light of the first illumination part which is a white light source or an infrared light source.

Next, a distance “W” in the “X”-axis is calculated by the following expression (1) based on the coordinates of the determined edge points “X1” and “X2”:

“W”=“X2”−“X1” Expression (1)

Further, when the vertical positions of the two horizontal lines are “Y1” and “Y2”, a distance “H” in the “Y”-axis is calculated by the following expressions (2).

“H”=“Y2”−“Y1” Expression (2)

Similarly, the coordinates “YY1” and “YY2” where two vertical lines intersect with an upper edge of the medium can be calculated. Although this processing is not shown, the pixel values are respectively checked along the vertical lines “X=XX1” and “X=XX2” to the lower direction with the upper end of the image as a starting point. Then, when the pixel values exceed the set threshold value “Thresh”, the points are determined as the edge points “YY1” and “YY2” and thus, the distance can be calculated.

### (Step S204)

Next, the angle calculation part 110 performs inclination angle calculation processing. The angle calculation part 110 calculates an inclination angle θ of the information recording medium 2 based on the above-mentioned the distance “W” in the “X”-axis and the distance “H” in the “Y”-axis by using the following expression (3).

θ=a tan (W/H) Expression (3)
where, a tan ( ) indicates arc tangent.

In this case, the “θ” of the expression (3) may be used as an inclination angle as it is. In order to further enhance a degree of precision, similar operations may be performed on the right end side of the medium and the angle is calculated together with the result on the left end side. In this case, for example, the average value is set as the final inclination angle.

In order to further enhance a degree of the precision, as described above, two vertical lines are drawn within the image, and an intersecting point of a first vertical line with the medium upper side edge is set as “YY1” and an intersecting point of a second vertical line with the medium upper side edge is set as “YY2”, and a distance “HH” which is a difference between them is calculated by the following expression (4).

“HH”=“YY2”−“YY1” Expression (4)

Further, when the positions of the two vertical lines are set to be “XX1” and “XX2”, the horizontal distance “WW” is calculated by the following expression (5).

“WW”=“XX2”−“XX1” Expression (5)

When these values are used, the inclination angle “θθ” can be calculated by the following expression (6):

θθ=a tan (HH/WW) Expression (6)
where, “WW”≠zero.

Similar operations may be performed for the lower end side of the medium to calculate the angle together with the result on the upper end side. In this case, for example, an average value of the angles on the upper end side and the lower end side is set as the final inclination angle. In addition, the inclination angles at four positions, i.e., the right and left sides and the upper and lower sides may be calculated to calculate an average value of all the inclination angles, and the average value is set as the final inclination angle. In this manner, the angle calculation process in accordance with at least an embodiment of the present invention is finished.

### [Details of Angle Correction Process]

Next, details of the angle correction process of the step S105 in FIG. 3 will be described below for each step with reference to a flow chart in FIG. 4B.

### (Step S300)

First, the apex calculation part 120 performs medium quadrangle apex calculation processing. The apex calculation part 120 calculates coordinates of respective apexes corresponding to the medium quadrangle in the processing object area which is cut out from the first image data 200.

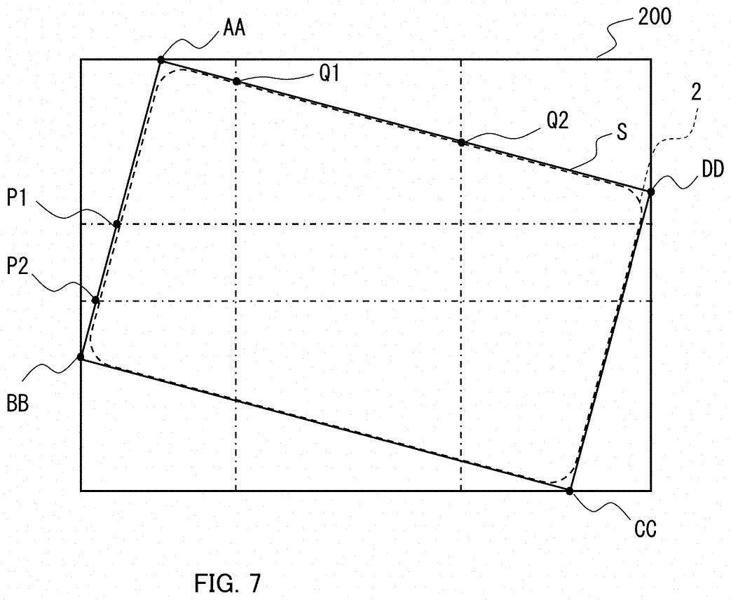

When described with reference to FIG. 7, first, the apex calculation part 120 calculates, similarly to the medium edge point deviation calculation processing of the step S203 in FIG. 4A, two edge points on the respective sides of the medium quadrangle and performs coordinate calculations of the respective apexes of the medium quadrangle. For example, the apex “AA” of the medium quadrangle can be, as shown in FIG. 7, calculated as an intersecting point of the straight line “P1-P2” formed by connecting the edge point “P1” (“X1” and “Y1”) with the edge point “P2” (“X2” and “Y2”) with the straight line “Q1-Q2” formed by connecting the edge point “Q1” (“XX1” and “YY1”) with the edge point “Q2” (“XX2” and “YY2”). Other three apexes “BB”, “CC” and “DD” can be similarly calculated. The apex calculation part 120 stores the coordinates of the respective calculated apexes of the medium quadrangle in the correction data 210.

### (Step S301)

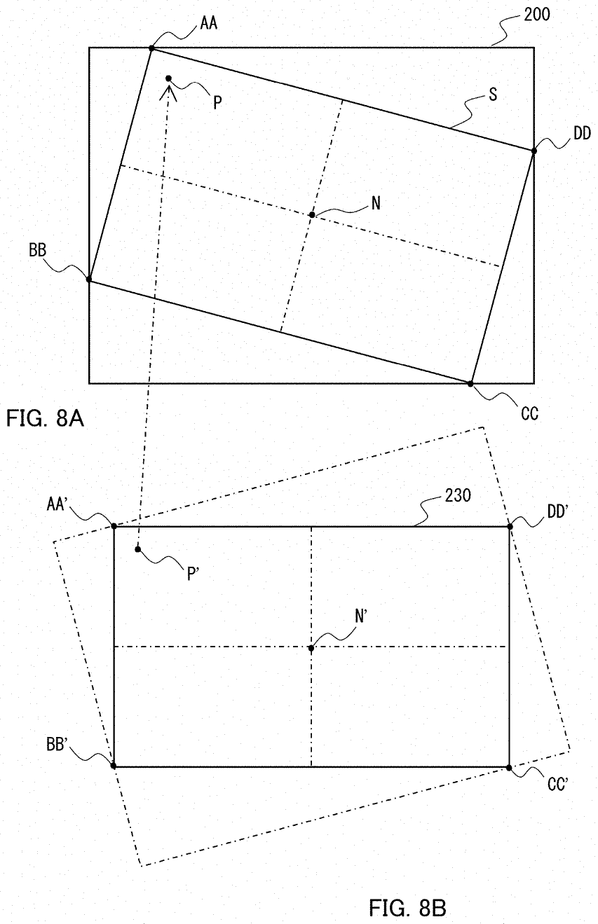

Next, the angle correction part 140 performs medium quadrangle apex coordinate conversion processing. This processing will be described below with reference to FIG. 8A and FIG. 8B. The angle correction part 140 reads out the inclination angle calculated by the angle calculation process from the correction data 210. After that, the coordinates of the four apexes “AA”, “BB”, “CC” and “DD” calculated by the medium quadrangle apex calculation processing are converted by using the following expression (7).

x′=cos θ×(x−Cx)+sin θ×(Py−Cy)+Cx′

y′=−sin θ×(x−Cx)+cos θ×(Py−Cy)+Cy′ Expression (7)

where, “θ” is the inclination angle, (x, y) are the coordinates on the processing object area of the respective apexes “AA”, “BB”, “CC” and “DD”, (Cx, Cy) are the coordinates of the center “N” on the processing object area, (x′, y′) are the coordinates of conversion destinations (to be converted) on the corrected image data 230, and (Cx′, Cy′) are the coordinates of the center “N′” on the corrected image data 230.

In this case, the (Cx, Cy) can be easily calculated by averaging the coordinates of the apexes “AA”, “BB”, “CC” and “DD” in the “X”-axis and the “Y”-axis.

FIG. 8A shows a state of the respective apexes before conversion, and FIG. 8B shows a state of the respective apexes after conversion. As shown in FIG. 8B, the outline of the medium quadrangle is mapped on the medium quadrangle of the “AA′”, “BB′”, “CC″” and “DD′”. In other words, when coordinate conversion is performed for the four apexes of the medium quadrangle so as to turn in a reverse direction by the inclination angle calculated by the angle calculation part 110, the inclination angle of the medium quadrangle after the conversion becomes zero. The angle correction part 140 secures a storage area of the corrected image data 230 corresponding to a quadrangle area (hereinafter, referred to as a “corrected quadrangle area”) based on the coordinates of the medium quadrangle of the “AA′”, “BB′”, “CC″” and “DD′” in the storage part 12.

### (Step S302)

Next, the angle correction part 140 performs coordinate reverse conversion correction processing. The angle correction part 140 acquires pixel values of all the pixels within the corrected quadrangle area formed of the four apexes of the medium quadrangle on the corrected image after the conversion based on the pixel positions before the correction corresponding to each of the pixels. In the example shown in FIG. 8B, finally, all the pixels of the mapped medium quadrangle of the “AA′”, “BB′”, “CC″” and “DD′”, in other words, the corrected quadrangle area are performed with reverse coordinate conversion by using the following expression (8):

Px=cosθ*(Px′−Cx′)−sin θ*(Py′−Cy′)+Cx

Py=sinθ*(Px′−Cx′)+cosθ*(Py′−Cy′)+Cy Expression (8)

where, “θ” is the inclination angle, (Px′, Py′) are the coordinates of an arbitrary pixel “P′” within the corrected quadrangle area, (Cx′, Cy′) are the coordinates of the center “N′” on the corrected image data 230, (Px, Py) are the coordinates of the corresponding pixel “P” of the conversion source (original) within the processing object area, and (Cx, Cy) are the coordinates of the center “N” on the processing object area.

In this processing, for example, while the angle correction part 140 respectively changes “Px′” and “Py′” to the “X”-axis direction and the “Y”-axis direction by one pixel in the “X”-axis direction and the “Y”-axis direction with double loop or the like, the angle correction part 140 replaces the pixel values of the corresponding pixel “P′” (Px′, Py′) with the pixel value of the pixel “P” (Px, Py) on the processing object area.

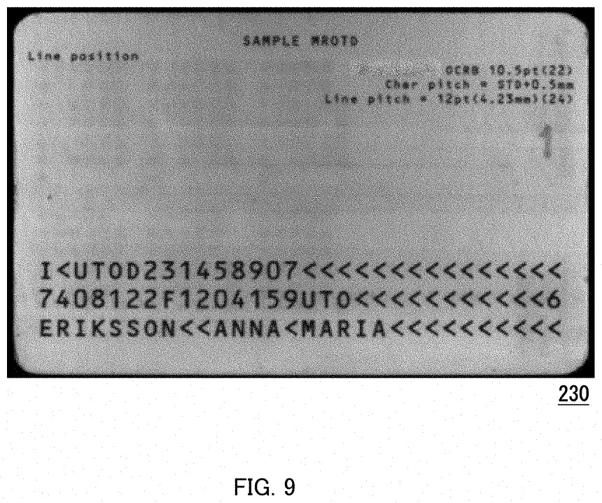

FIG. 9 is a photo of the corrected image data 230 in which the angle has been corrected by the above-mentioned process. It can be understood that there is no missing or omission of pixels on the image after the conversion. In other words, according to the angle correction process in this embodiment, omission of the pixels on the corrected image data 230 after the conversion can be completely prevented. This is because that, in the coordinate reverse conversion correction processing in this embodiment, the coordinates of a pixel “P” of the processing object area are calculated with the coordinates of the pixel “P′” in the corrected quadrangle area of the corrected image data 230 as a reference. In other words, there is no pixel whose pixel value is not acquired in the corrected quadrangle area.

In addition, the coordinate conversion of the respective apexes of the medium quadrangle is performed and the pixel value of the corresponding pixel is acquired based on this coordinate system. Therefore, the distortion of the edge and the like can be suppressed and the corrected image data 230 having a further high quality can be prepared. In this way, the angle correction process in accordance with at least an embodiment of the present invention is finished.

[Principal Effects in this Embodiment]

When structured as described above, the following effects can be obtained. Conventionally, an angle correction technique in which an edge of an information recording medium is detected to correct an angle is effective to an scanned image with white light or infrared light as a light source. On the other hand, in an image scanner such as a conventional multi-document scanner, information which is main recorded information such as character information and a photo and information such as a mark for authenticity determination are required to be scanned simultaneously. The information for authenticity determination is often recorded so as to be capable of being discriminated only under illumination of ultraviolet rays which are invisible.

However, contrast of a medium area with a background area may often become unclear in the image scanned with ultraviolet light or the like as a light source. In this case, detection accuracy of the intersecting point coordinate may be remarkably deteriorated. Therefore, in the image scanner such as a multi-document scanner in the conventional system, an angle correction of an information recording medium scanned with ultraviolet light or the like as a light source is unable to be executed precisely.

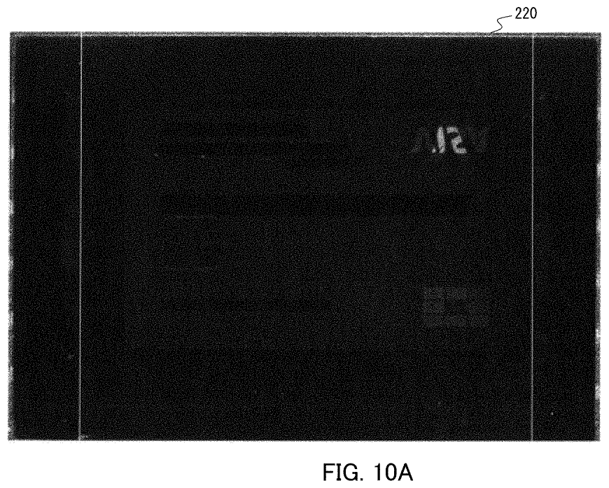

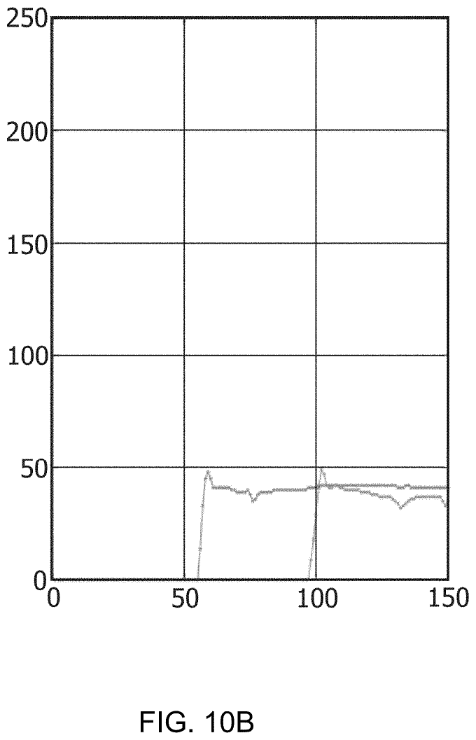

As a reference example, FIG. 10A and FIG. 10B show a case that edge points of the second image data 220 are to be calculated. FIG. 10A shows a photo of the second image data 220. As shown in FIG. 10A, in the second image data 220, the contrast of the outline is low. FIG. 10B shows pixel values of two horizontal lines in the vicinity of the left edge similarly to FIG. 6B. In other words, in comparison with the first image data 200 shown in FIG. 6B, the second image data 220 have relatively small pixel values and thus, detection of a boundary position between the information recording medium 2 and the background is likely to be inaccurate.

As described above, in a case that ultraviolet light is used as an illumination light source, the contrast of the information recording medium 2 with the background is not satisfactory and thus, the contrast of the outline becomes low and it is difficult to calculate the edge point.

On the other hand, the image processing device 10 in accordance with at least an embodiment of the present invention includes the first image acquisition part 100, which acquires first image data 200 including an information recording medium 2 captured under irradiation of light of a first wavelength range, the angle calculation part 110 which calculates an inclination angle of the information recording medium 2 based on the first image data 200 acquired by the first image acquisition part 100, the second image acquisition part 130 which acquires second image data 220 including the information recording medium 2 captured at the same position under irradiation of light of a second wavelength range whose wavelength range is different from the first wavelength range and in which contrast of an outline is low, and the angle correction part 140 which prepares corrected image data 230 of the second image data 220 acquired by the second image acquisition part 130 in which an angle of the information recording medium 2 is corrected by the inclination angle calculated by the angle calculation part 110.

According to this structure, like the second image data 220 acquired with the second wavelength such as ultraviolet light, even in the second image data 220 in which contrast of the outline of the information recording medium 2 is low, the second image data 220 can be corrected by using the correction data 210 of the first image data 200 acquired with the first wavelength such as white light or infrared light. In other words, the correction data 210 and the coordinate data of the respective apexes of the circumscribed quadrangle can be used as they are for the second image data 220 captured with ultraviolet light as a light source. As a result, also in the second image data 220 acquired with the second wavelength, an angle correction can be performed without utilizing the contrast of the outline of the information recording medium 2.

On the other hand, in the conventional angle correction process, coordinate conversion processing is performed in which image data of a processing object area are turned in a reverse direction with respect to a detected turning angle of the information recording medium. As a result, an image of the information recording medium having no inclination may be prepared.

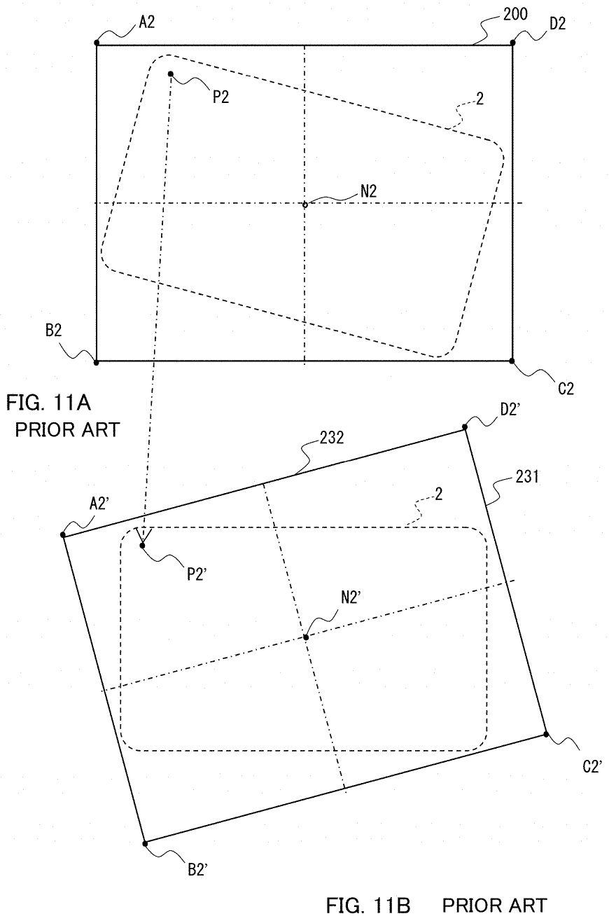

As a reference, an example will be described below in which a conventional angle correction process is applied to the first image data 200 with reference to FIG. 11A and FIG. 11B. FIG. 11A is a concept diagram showing a processing object area of the first image data 200. The broken line in the drawing indicates an information recording medium 2 in an inclined state. In the conventional angle correction process, the coordinate of the conversion destination is calculated for all the pixels within the processing object area surrounded by the apexes “A2”, “B2”, “C2” and “D2” by using the following expression (9), and the pixels are mapped on the positions shown in FIG. 11B.

Px′=cosθ×(Px−Cx)+sin θ×(Py−Cy)+Cx′

Py′=−sin θ×(Px−Cx)+cos θ×(Py−Cy)+Cy′ Expression (9)

where, “θ” is an inclination angle, (Px, Py) are the coordinates of the pixel “P2” on the processing object area, (Cx, Cy) are the coordinates of the center “N2” of the processing object area, (Px′, Py′) are the coordinates of the pixel “P2” of the conversion destination on the corrected image data 231, and (Cx′, Cy′) are the coordinates of the center on the corrected image data 231.

In the conventional image correction process, the coordinate conversion is executed for all the pixels of the quadrangle surrounded by the apexes “A2”, “B2”, “C2” and “D2” of the processing object area of the first image data 200 shown in FIG. 11A. In other words, all the pixels within the circumscribed quadrangle including the medium quadrangle are mapped within an area surrounded by the rectangle formed by “A2”, “B2”, “C2” and “D2”. The inclined angle of the medium shown by the broken line in the drawing becomes zero by the operation. In other words, in the conventional angle correction process, the coordinate of the pixel “P2” of the corrected quadrangle area of the corrected image data 230 is calculated with the coordinate of the pixel “P2” of the processing object area as a reference.

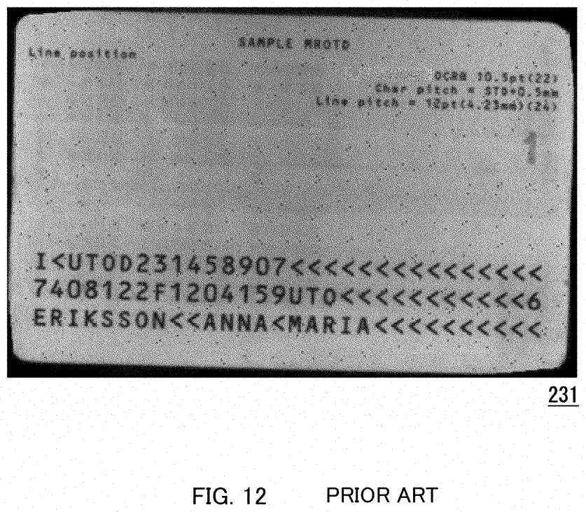

However, as described above, when the original image is used as the object of coordinate conversion and a coordinate value of conversion destination is calculated from the coordinate value of the original image based on the conversion expression, distortion occurs due to a calculation error. An example that an angle correction is actually performed for the first image data 200 according to this system is shown in FIG. 12. As shown in this photo, omissions of pixels occur on the image of conversion destination by distortion due to a calculation error. Black points shown in FIG. 12 correspond to omitted pixels in the corrected image data 231.

The omissions of the pixels on the image after conversion can be prevented by oversampling or the like, but the distortion itself cannot be eliminated and thus, it is required to average the pixel values of the peripheral pixels. Therefore, the image is blurred. In the corrected image data 231 whose quality is deteriorated as described above, a problem may occur in subsequent recognition processing of characters or a bar-code. In addition, when oversampling or the like is performed, time for the processing is required and the processing cost is also required.

On the other hand, the image processing device 10 in accordance with at least an embodiment of the present invention includes the image acquisition part which acquires image data including an information recording medium 2 captured under irradiation of light, the angle calculation part 110 which calculates an inclination angle of the information recording medium 2 based on the image data acquired by the image acquisition part, the apex calculation part 120 which calculates the coordinates of respective apexes corresponding to a quadrangle of the information recording medium 2 based on the image data acquired by the image acquisition part, and the angle correction part 140 which corrects the coordinates of the respective apexes calculated by the apex calculation part 120 with the inclination angle calculated by the angle calculation part 110, and the angle correction part 140 preparing corrected image data 230 by acquiring pixel values of pixels of image data located at coordinates reversely converted by the inclination angle for a coordinate of each pixel within a quadrangle formed by respective apexes whose inclination is corrected.

According to this structure, the inclination of the coordinates of the respective apexes of the information recording medium 2 is corrected, and the inclination of the medium is corrected for the respective coordinates on an inner side of the apex coordinates after correction by reverse coordinate conversion. In this case, a pixel value is acquired from the pixel position before correction corresponding to the pixel for all the pixels within the corrected quadrangle area which is formed by four apexes of a medium quadrangle on the image after conversion. As a result, in the corrected image data 230 after correction, a defect of pixel omissions due to calculation errors or the like is prevented and high quality can be attained.

In addition, a pixel of an appropriate coordinate is selected for each pixel of the corrected image data 230 in the processing object area of the first image data 200 in comparison with a conventional case. Therefore, quality of the corrected image data 230 is enhanced in comparison with a conventional case. As a result, further correct information can be easily obtained in a subsequent processing for the corrected image data 230 after the angle correction has been performed. Further, the angle correction can be performed by a comparatively simple calculation and thus, a dedicated correction circuit, software and the like are not required and an inexpensive image processing device 10 can be provided.

In addition, in the conventional angle correction process, the entire circumscribed quadrangle is turned on the basis of the coordinates of the four apexes of the circumscribed quadrangle which are calculated in the process calculating an inclination angle of the information recording medium 2. Therefore, a calculation error becomes large.

On the other hand, in the image processing device 10 in this embodiment, the coordinate conversion is performed in which four apexes of the medium quadrangle calculated by a process calculating an inclination angle of the information recording medium 2 are turned by the inclination angle in a reverse direction.

As described above, turning is performed on the basis of the coordinates of the four apexes turned on the basis of the respective apexes of the medium quadrangle which is an area of the information recording medium 2 and thus, in comparison with a case that the coordinates of four apexes of the circumscribed quadrangle outside the medium quadrangle, a calculation error becomes small. As a result, the corrected image data whose distortion due to a turning error is further reduced can be acquired in the area of the information recording medium 2. Actually, when compared with the reference example of the corrected image data 231 shown in FIG. 12 in the conventional system, distortion of the edge and the like are also reduced in the corrected image data 230 shown in FIG. 9 by the system in this embodiment.

In the image processing device 10 in accordance with at least an embodiment of the present invention, the angle calculation part 110 calculates respective intersecting points of two parallel straight lines drawn so as to pass the information recording medium 2 for either axis of the first image data 200 with an edge of the information recording medium 2, and the angle calculation part 110 calculates the inclination angle of the information recording medium 2 based on a distance in a horizontal direction and a distance in a vertical direction between the respective intersecting points having been calculated. According to this structure, the inclination angle can be calculated with easy calculation. In other words, an angle can be calculated easily by a normal trigonometric function such as a tan ( ) (arc tangent) or the like.

In the image processing device 10 in accordance with at least an embodiment of the present invention, the angle calculation part 110 detects four end points based on luminance values in respective lines in each of the axial directions, calculates a circumscribed quadrangle of the information recording medium 2 based on the four detected end points, and data outside the circumscribed quadrangle are excluded and removed from the first image data 200. According to this structure, unnecessary data are removed in advance and thus, a speed of subsequent processing such as angle correction processing can be increased. Further, in the storage part 12, an area of necessary working memory, an area of corrected image data 230, and the like can be also reduced. In addition, the four end points are calculated by projection of average or sum total of luminance values (output value) in the respective lines in each of the axial directions and thus, the coordinates of the circumscribed quadrangle can be surely calculated.

In the image processing device 10 in accordance with at least an embodiment of the present invention, the angle correction part 140 performs an angle correction of the information recording medium 2 with the center coordinate of the information recording medium 2 as a center of turning. According to this structure, the information recording medium 2 after correction is easily located in the center of the corrected image data 230. Therefore, a load and the like of subsequent recognition processing of characters and a bar-code can be suppressed and a recognition error can be reduced.

In the image processing device 10 in accordance with at least an embodiment of the present invention, the light of the first wavelength range is one of visible light and infrared light, and the light of the second wavelength range is ultraviolet light. According to this structure, an angle of the image captured by using ultraviolet light can be corrected by using data of the image captured by using visible light and/or infrared light. In other words, in a case that image data are acquired, when illumination light is light of the first wavelength range which is either visible light or infrared light, the correction data 210 and the coordinate data of the respective apexes of the circumscribed quadrangle are calculated and, in a case that illumination light is light of the second wavelength range which is ultraviolet light, the information having been held can be used (maintained) as it is.

As a result, according to this structure, an angle correction of the UV image whose contrast is low can be performed with a similar degree of accuracy to the case of a white image or an infrared image. In other words, even when contrast of the medium area with the background area is unclear, an angle correction can be performed with a degree equivalent to the image acquired with white light and infrared light.

The image scanner 1 in accordance with at least an embodiment of the present invention includes the image processing device 10, the placing part 20 where an information recording medium 2 is placed, the first irradiation part 31 structured to irradiate light of a first wavelength range to the information recording medium 2 placed on the placing part 20, the second irradiation part 32 structured to irradiate light of a second wavelength range to the information recording medium 2 placed on the placing part 20, and the imaging part 40 structured to capture the first image data 200 and the second image data 220. According to this structure, in the image scanner 1 such as a multi-document scanner, an image correction process can be easily realized by the image processing device 10 in this embodiment.

### Other Embodiments

In the embodiment described above, an example is described in which an image correction process of an angle correction where an inclination of the medium quadrangle is set to be zero is performed for the second image data 220 by using correction data 210. However, irrespective of an inclination, it may be configured that cropping processing or the like by which image of a background portion with respect to the information recording medium 2 is removed is executed. In other words, with the use of the coordinate data of the respective apexes of the circumscribed quadrangle, the coordinate data of the respective apexes of the medium quadrangle, and the like, which are calculated for the first image data 200, image data except these portions of the second image data 220 may be eliminated.

Further, not limited to the above-mentioned processing, for example, processing may be performed so that coordinates of pixels of a background portion are calculated based on the first image data 200 by image recognition and are set in the correction data 210 and, based on the results, cropping of the second image data 220 is performed. In addition, other than cropping, combining processing may be performed that the second image data 220 are combined and indicated with a line or the like of the medium quadrangle calculated with the first image data 200, or it may be configured that matching or the like is performed in subsequent recognition processing of invisible mark or the like. According to this structure, the configuration can be easily applied to various processings.

In addition, in the embodiment described above, a process is described in which an inclination angle of a medium quadrangle within the first image data 200 is detected and image correction is performed so that the inclination of the medium quadrangle becomes zero. However, in a case that an information recording medium 2 is formed in a quadrangular shape such as a rectangle, a booklet type medium such as a passport other than a card medium can be applied. In addition, due to distortion by pressing an information recording medium 2 against the placing part 20, even when the medium does not become rectangular, an angle correction may be performed based on respective inclination angles of respective sides.

Further, in the embodiment described above, after the first image data 200 and the second image data 220 are acquired as image data, processes for respective processing objects are performed. However, it may be configured that processing on the first image data 200 is performed and correction data 210 are set and, after that, the first image data 200 are erased or overwritten when the second image data 220 are acquired. In addition, it may be configured that the image data of the first image data 200 after the angle correction have been outputted to a host apparatus and then, the corrected image data 230 are erased or overwritten at the time of processing of the second image data 220. According to this structure, storage capacity of the storage part 12 is capable of being saved.

In addition, in the embodiment described above, an example is described in which an image correction process is performed on the first image data 200 and the second image data 220. However, the image correction process may be performed only on the first image data 200. In addition, the first image data 200 may be color image data instead of monochrome bitmap data. In this case, as a color, a bit map image such as RGB colors and colors with a color difference may be used. In addition, data of a format such as “jpg” can be converted into bitmap data by a pixel unit and used. Further, as lights of a first wavelength range and a second wavelength range, light further shorter in wavelength such as X-rays or an electromagnetic wave having a long wavelength such as a terahertz wave can be irradiated. In addition, as lights of a first wavelength range and a second wavelength range, light of various laser sources such as a semiconductor laser, a fiber laser, a solid-state laser, a gas laser and a liquid laser may be used. In this case, as lights of a first wavelength range and a second wavelength range, light of a single wavelength may be respectively used, and light of a plurality of wavelengths through an optical system including a phosphor may be used.

In addition, it may be structured that a transparent flat bed is provided as the placing part 20 and image data on a front side and a back side of an information recording medium 2 which is placed are simultaneously captured by two imaging part 40. In this case, when a positional relationship between image data on the front side and the back side is calibrated in advance, one of the image data is reversed to perform inclination correction similarly to the embodiment described above. In other words, an inclination of one of the image data on the front side and the back side can be corrected by using the other image data. In addition, in this case, when light of a first wavelength range is irradiated to one of the front side and the back side and imaged, and light of a second wavelength range is irradiated to the other side and imaged, on the basis of the image data on the side where the light of the first wavelength range is irradiated, the image data on the other side can be corrected. According to this structure, imaging time can be shortened and a processing load can be suppressed.

Although the present invention has been shown and described with reference to a specific embodiment, various changes and modifications will be apparent to those skilled in the art from the teachings herein.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An image processing device for use with an information recording medium, the image processing device comprising:
a first image acquisition part configured to acquire first image data including an information recording medium captured under irradiation of light of a first wavelength range;
an angle calculation part configured to calculate an inclination angle of the information recording medium based on the first image data acquired by the first image acquisition part;
a second image acquisition part configured to acquire second image data including the information recording medium captured at a same position under irradiation of light of a second wavelength range whose wavelength range is different from the first wavelength range and in which contrast of an outline of the information recording medium is low; and
an angle correction part configured to prepare corrected image data of the second image data acquired by the second image acquisition part in which an angle correction of the information recording medium is performed based on the inclination angle calculated by the angle calculation part.

2. The image processing device according to claim 1, wherein
the angle calculation part is configured to calculate respective intersecting points of two parallel straight lines drawn so as to pass the information recording medium with an edge of the information recording medium for either axis of the first image data, and
the angle calculation part is configured to calculate the inclination angle of the information recording medium based on a distance in a horizontal direction and a distance in a vertical direction between the respective intersecting points having been calculated.

3. The image processing device according to claim 1, wherein the angle calculation part is configured to detect four end points based on luminance values in respective lines in each of axial directions, calculates a circumscribed quadrangle of the information recording medium based on the four end points having been detected, and data outside the circumscribed quadrangle are removed from the first image data.

4. The image processing device according to claim 1, wherein the angle correction part is configured to perform the angle correction of the information recording medium with the center coordinate of the information recording medium as a center of turning.

5. The image processing device according to claim 1, wherein
the light of the first wavelength range is one of visible light and infrared light, and
the light of the second wavelength range is ultraviolet light.

6. An image scanner comprising:
the image processing device defined in claim 1;
a placing part where the information recording medium is placed;
a first irradiation part structured to irradiate the light of the first wavelength range to the information recording medium placed on the placing part;
a second irradiation part structured to irradiate the light of the second wavelength range to the information recording medium placed on the placing part; and
an imaging part structured to capture the first image data and the second image data.

7. An image processing method executed by an image processing device, the image processing method comprising;
acquiring first image data including an information recording medium captured under irradiation of light of a first wavelength range;
calculating an inclination angle of the information recording medium based on the first image data having been acquired;
acquiring second image data including the information recording medium captured at a same position under irradiation of light of a second wavelength range whose wavelength range is different from the first wavelength range and in which contrast of an outline of the information recording medium is low; and
performing an angle correction of the information recording medium with respect to the second image data based on the inclination angle having been calculated.

8. The image processing device according to claim 2, wherein the angle calculation part is configured to detect four end points based on luminance values in respective lines in each of axial directions, calculates a circumscribed quadrangle of the information recording medium based on the four end points having been detected, and data outside the circumscribed quadrangle are removed from the first image data.

9. The image processing device according to claim 8, wherein the angle correction part is configured to perform the angle correction of the information recording medium with the center coordinate of the information recording medium as a center of turning.

10. The image processing device according to claim 9, wherein
the light of the first wavelength range is one of visible light and infrared light, and
the light of the second wavelength range is ultraviolet light.

11. An image scanner comprising:
the image processing device defined in claim 10;
a placing part where the information recording medium is placed;
a first irradiation part structured to irradiate the light of the first wavelength range to the information recording medium placed on the placing part;
a second irradiation part structured to irradiate the light of the second wavelength range to the information recording medium placed on the placing part; and
an imaging part structured to capture the first image data and the second image data.

12. The image processing device according to claim 2, wherein the angle correction part is configured to perform the angle correction of the information recording medium with the center coordinate of the information recording medium as a center of turning.

13. The image processing device according to claim 3, wherein the angle correction part is configured to perform the angle correction of the information recording medium with the center coordinate of the information recording medium as a center of turning.

14. An image processing device for use with an information recording medium, the image processing device comprising:
a first light source structured to emit light of a first wavelength range;
a second light source structured to emit light of a second wavelength range different from the first wavelength range;
an imager structured to capture image data of the information recording medium;
a controller configured to:
acquire first image data of the information recording medium captured under irradiation of light of the first wavelength range;
calculate an inclination angle of the information recording medium based on the first image data;
acquire second image data of the information recording medium captured at a same position under irradiation of light of the second wavelength range and in which contrast of an outline of the information recording medium is low; and
prepare corrected image data of the second image data in which an angle correction of the information recording medium is performed based on the inclination angle.
